(19) United States
(12) Patent Application Publication
(10) Pub. No.: US 2012/0292583 A1
(43) Pub. Date: Nov. 22, 2012

(54) BLOCK

(76) Inventors: Charles J. Lob, Oconomowoc, WI (US); Kenneth E. Lange, Brookfield, WI (US)

(21) Appl. No.: 13/296,210

(22) Filed: Nov. 14, 2011

Related U.S. Application Data
(60) Provisional application No. 61/413,370, filed on Nov. 12, 2010.

(51) Int. Cl. B66D 3/04

(52) U.S. Cl. 254/390

(57) ABSTRACT

A block including first and second generally identical side plates that engage one another and rotatably capture a sheave between them. The side plates may includes interlocking tabs to secure the engagement between the side plates or a separate clip may be used to engage elements of the side plates to secure the plates to each other.

### CROSS-REFERENCE TO RELATED APPLICATION

The present application claims priority to earlier filed U.S. Provisional Application Ser. No. 61/413,370, filed on Nov. 12, 2010, the disclosure of which is incorporated herein by reference in its entirety.

### BACKGROUND

Improvements to existing blocks for use in sailing or other applications are desirable to achieve some or all of the following: reduce the cost of construction, reduce the part count; eliminate or reduce separate fasteners needed to assemble a block, and improve overall strength of the block. These do not represent the entire list advantages that may be achieved or which may be desirable to be achieved by an improved block.

The present disclosure relates to an approach to the design, construction and assembly of blocks that may address some or all of the above goals, in addition to achieving other improvements that may be apparent to those having skill in the related art.

### BRIEF DESCRIPTION OF THE DRAWINGS

The accompanying drawing figures, which are incorporated in and constitute a part of the description, illustrate several aspects of the invention and together with the description, serve to explain the principles of the invention. A brief description of the figures is as follows:

FIG. 1 is a first side view of a block according to the present disclosure, with a portion of the block removed to illustrate the positioning of a clip to secure the side plates to the block.

FIG. 2 is an edge view of the block of FIG. 1.

FIG. 3 is a top view of the block of FIG. 1.

FIG. 4 is a second side view of the block of FIG. 2.

FIG. 5 is a cross-sectional view of the block of FIG. 1 taken along line A-A of FIG. 4.

FIG. 6 is a bottom view of the block of FIG. 1 with the sheave removed for clarity.

FIG. 7 is an exploded perspective view of the block of FIG. 1.

FIG. 8 is a perspective view of a second embodiment of a block according to the present disclosure.

FIG. 9 is an edge view of the block of FIG. 8.

FIG. 10 is a top view of the block of FIG. 8.

FIG. 11 is a side view of the block of FIG. 8.

FIG. 12 is a bottom view of the block of FIG. 8 with the sheave removed for clarity.

FIG. 13 is an exploded perspective view of the block of FIG. 8.

### DESCRIPTION

Reference will now be made in detail to exemplary aspects of the present invention which are illustrated in the accompanying drawings. Wherever possible, the same reference numbers will be used throughout the drawings to refer to the same or like parts.

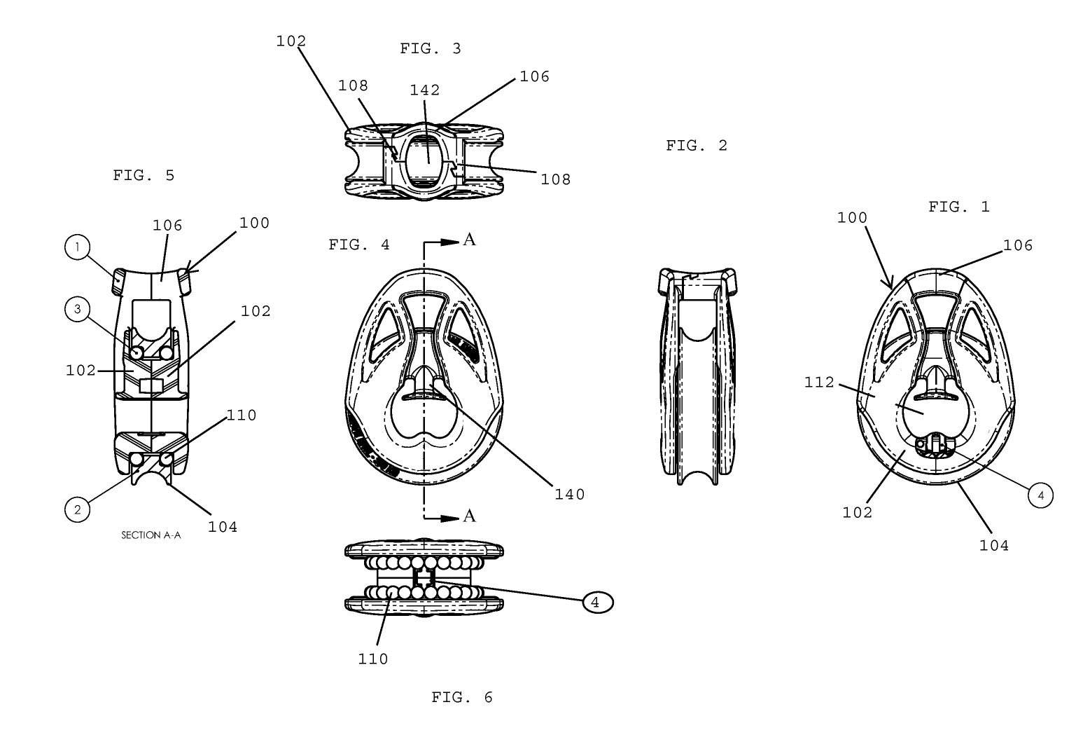

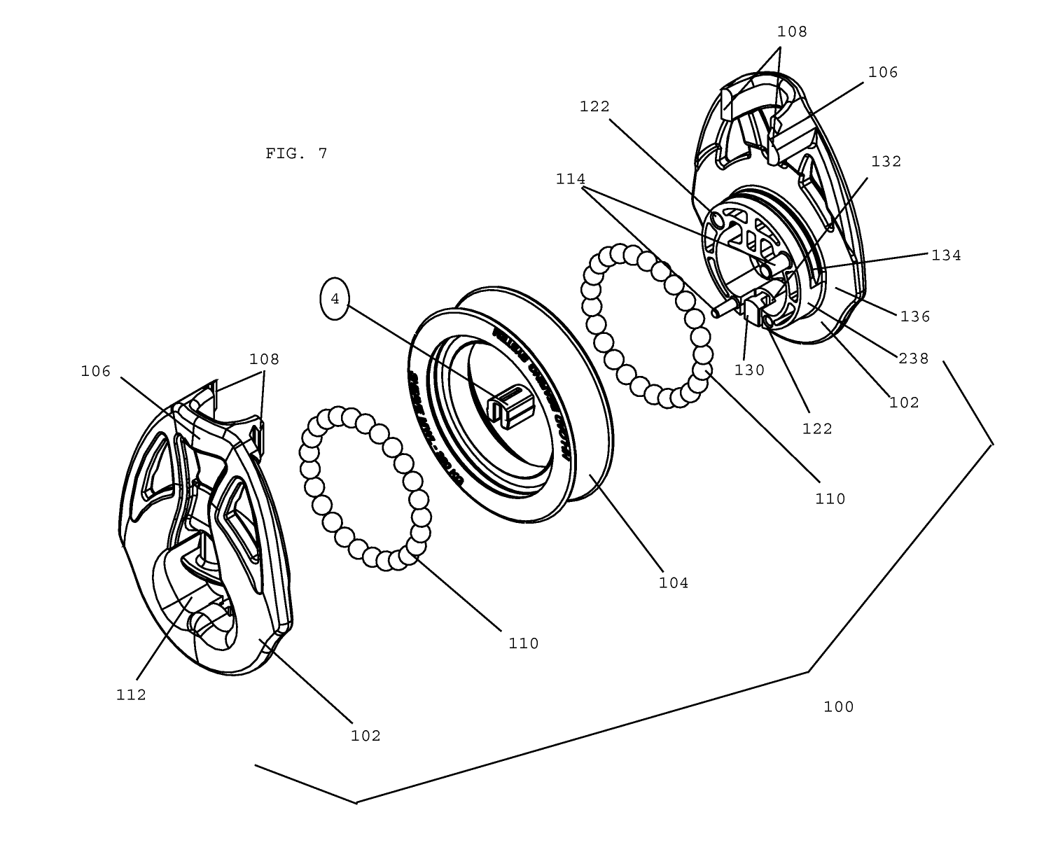

FIGS. 1 to 7 illustrate an improved block 100, preferably for use on sailboats but adaptable for use in other applications and settings. Block 100 may include a pair of generally identical side plates 102 with a sheave 104 rotatably mounted between the side plates. At a top 106 of the side plates 102 are a pair of interlocking tabs 108 that are configured to releasably secure the side plates 102 to each other. Within an opening 112 of side plates 102 about which sheave 104 rotates is positioned a clip indicated by number 4 within a circle. Clip 4 is configured to interact with and cooperate with an element 130 of the side plates 102 to secure the bottom of the side plates to each other. Clip 104 may preferably be inserted within grooves or recesses 132 on either side of element 130. Clip 104 is preferably inserted into engagement with elements 130 from within opening 112 and pressed downward into grooves 132.

Opening 112 is preferably configured to receive a line or other flexible securing member to secure block 100 to a sailboat or some other surface or device. A post 140 may be positioned within opening 112 to permit a bight or loop of line passing through an opening 142 adjacent top 106 and into opening 112. A second bight or loop of line may be passed through opening 142 and into opening 112 from an opposite side and secured about post 140.

Sheave 104 may be preferably mounted to the side plates on top of ball bearing 110 to permit smooth rotation. Other types of bearings may be used within the scope of the present disclosure, such as but not limited to roller, needle, bushing, hybrid, etc.

As shown in FIG. 7, the interior surfaces of side plates 102 may include additional engaging features such as but not limited to pins 114 that may be configured and positioned to engage openings 122 to ensure proper relative orientation and positioning of the side plates. These engaging features may also provide added structural integrity to the assembly block 100. It is anticipated that no additional engaging features may be needed for some configurations or embodiments of blocks according to the present disclosure. It is further anticipated that the pins and openings may have integral interlocking elements to further secure the side plates to each other. It is also anticipated that the interlocking features may be combined with the engaging features.

Side plate 102 may include a bearing track 134 within a portion of sheave receiving space 136, with the bearing track 134 positioned toward top 106 along an inner wall 138. Since the primary loads placed on a rope or line running through sheave 104 will come from opposite top 106, the highest loading about the circumference of the sheave will be adjacent bearing track 134. Bearing track 134 will ensure that bearings 110 remain in a preferred alignment between sheave 104 and side plate 102. Bearing tracks 134 may also include some reinforcement or strengthening materials to aid in the resisting of these loads placed on the sheave and improve wear resistance.

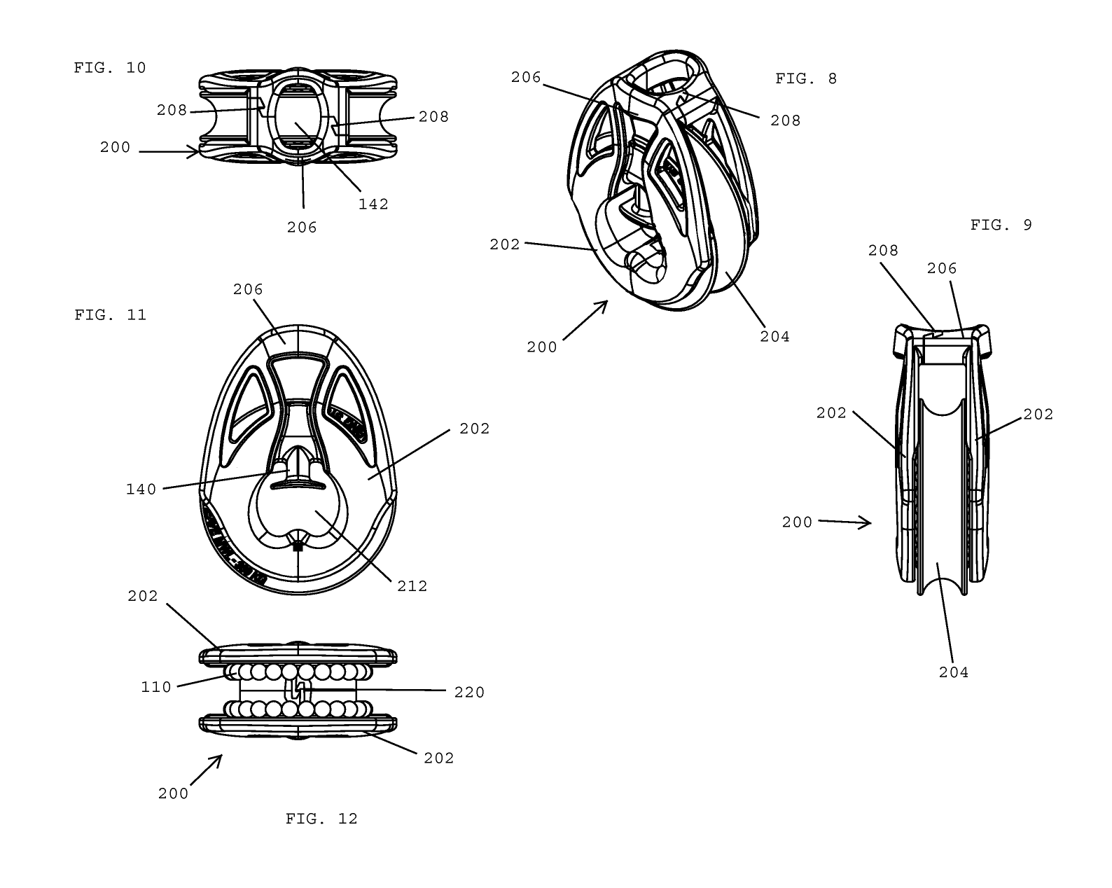

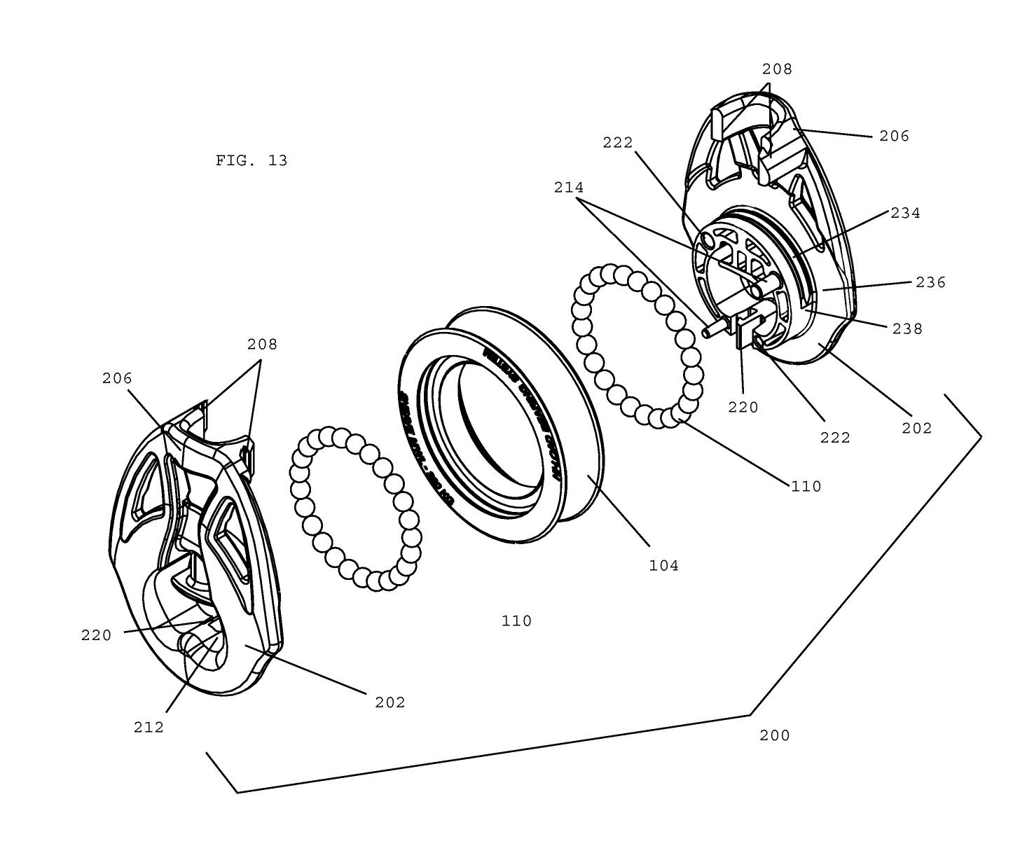

FIGS. 8 to 13 illustrate a block 200 according to the present disclosure which does not require any additional elements (such as clip 4, described above with regard to block 100) beyond a pair of preferably identical side plates 202 to secure the block assembly. A sheave 104 may be mounted between the side plates 202 with an opening 212 in the side plates extending through a center of the sheave. Adjacent a top 206 of each side plate 202 of block 200 is a first interlocking tab 208. Tabs 208 from the pair of side plates 202 of block 200 engage each other and cooperate to releasably secure the assembly of the side plates about the sheave. At a bottom of each side plate 202 opposite top 206 is a second interlocking tab 220. Tabs 220 from the pair of side plates 202 of block 200 enage each other and cooperate to releasably secure the assembly of the side plates about the sheave.

As shown in FIG. 12, the interior surfaces of side plates 202 may include additional engaging features such as but not limited to pins 214 that may be configured and positioned to engage openings 222 to ensure proper relative orientation and positioning of the side plates. These engaging features may also provide added structural integrity to the assembly block 200. It is anticipated that no additional engaging features may be needed for some configurations or embodiments of blocks according to the present disclosure. It is further anticipated that the pins and openings may have integral interlocking elements to further secure the side plates to each other. It is also anticipated that the interlocking features may be combined with the engaging features.

Side plate 202 may include a bearing track 234 within a portion of sheave receiving space 236, with the bearing track 234 positioned toward top 206 along an inner wall 238. Since the primary loads placed on a rope or line running through sheave 204 will come from opposite top 206, the highest loading about the circumference of the sheave will be adjacent bearing track 234. Bearing track 234 will ensure that bearings 110 remain in a preferred alignment between sheave 204 and side plate 202. Bearing tracks 234 may also include some reinforcement or strengthening materials to aid in the resisting of these loads placed on the sheave and improve wear resistance.

When assembled as shown herein, both block 100 and 200 are configured so that the engagement or interlocking of the tabs or the pins and corresponding openings will prevent the side plates from rotating with respect to each other and retain the sheave and any supporting bearings between the side plates.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A block comprising:
first and second side plates configured to releasably engage each other, the first and second side plates being generally identical to each other;
a sheave rotatably mounted between the side plates.

2. The block of claim 1, wherein the side plates are held together by the engagement of tabs adjacent a top and a bottom of the side plates.

4. The block of claim 3, wherein the side plates are held together solely by the direct engagement of the tabs which interlock with each other.

5. The block of claim 3, wherein the side plates are held together by the direct engagement of the tabs adjacent one of the top or the bottom of the side plates and a clip positioned over the tabs at the other of the top or the bottom of the side plates.

6. The block of claim 5, wherein the clip is positioned over the interlocking tabs adjacent the bottom of the side plates and is positioned over the tabs from within an opening in the side plates within the sheave.

7. The block of claim 1, further comprising each side plate including a sheave receiving space, the receiving space including an inner wall forming a central opening through the side plates, wherein at least one bearing is positioned between the sheave and the inner wall of the sheave receiving space.

8. The block of claim 7, further comprising a bearing track along the inner wall on portion of the inner wall positioned toward a top of the block.

9. The block of claim 1, further comprising the side plates cooperating to define an opening through the block extending within the sheave, the opening configured to receive lines to secure the block.

10. The block of claim 1, each side plate further comprising one or more pins extending toward the other side plate and engaging a corresponding opening on the other side plate.
